(19) United States
(12) Patent Application Publication
(10) Pub. No.: US 2012/0137641 A1
(43) Pub. Date: Jun. 7, 2012

(54) TOP-EMPTYING DEHUMIDIFIER

(75) Inventors: Rich Thrush, Jersey City, NJ (US); William Fiebel, Succasunna, NJ (US); Adam Sebastian Sanchez, Nutley, NJ (US); John Franks, Hopkinton, MA (US); Michael Joseph Poindexter, New York, NY (US)

(73) Assignee: Kaz USA, Inc., Southborough, MA (US)

(21) Appl. No.: 13/267,117

(22) Filed: Oct. 6, 2011

Related U.S. Application Data
(60) Provisional application No. 61/390,470, filed on Oct. 6, 2010.

(51) Int. Cl. B01D 53/26

(52) U.S. Cl. 55/357; 55/423

(57) ABSTRACT

A dehumidifier has a main body and a water collection container that is removably and fluidly coupled to the main body. The main body includes a dehumidifier device to dehumidify air surrounding or fed into the dehumidifier. The water collection container couples to the main body to receive water output by the dehumidifier device. The main body and the water collection container are configured so that the water collection container is disposed closer to a top of the dehumidifier than to a bottom of the dehumidifier. The water collection container preferably has a handle in which the handle is closer to the top of the dehumidifier than to the bottom of the dehumidifier.

### CROSS-REFERENCE TO RELATED APPLICATIONS

This application claims the benefit under 35 U.S.C. §119(e) of U.S. Provisional Application No. 61/390,470, filed on Oct. 6, 2010, the contents of which are incorporated herein by reference.

### BACKGROUND OF THE INVENTION

1. Field of the Invention

The present invention relates to dehumidifiers, and more specifically, preferred embodiments relate to dehumidifiers that can be emptied from the top of the device.

2. Description of the Related Art

Dehumidifiers that are known in the art generally include a water collection container that is located at or near the bottom of the dehumidifier. The water collection container stores water that the dehumidifier removes from the air. When the water collection container becomes full, a user generally must remove the water collection container from the dehumidifier, empty it, and then return it to its position in the dehumidifier, so as to permit the dehumidifier to continue to store the water that the device removes from the air.

When the water collection container is positioned at or near the bottom of the dehumidifier, as in the dehumidifiers of the prior art, the user must bend down to grasp and remove the water collection container. This involves several disadvantages. First, it may be uncomfortable for the user to bend down to grasp the water collection container. Second, the user may injure himself or herself by bending down to grasp the water collection container. Third, the user may unintentionally spill water from the water collection container while bending down and removing it from the dehumidifier.

Therefore, a need exists for a dehumidifier that addresses these and other problems of the prior art.

### SUMMARY OF THE INVENTION

In order to address these and other disadvantages of the dehumidifiers of the prior art, various preferred aspects of the invention are directed to a dehumidifier having a main body and a water collection container that is removably and fluidly coupled to the main body. The main body includes a dehumidifier device to dehumidify air surrounding or fed into the dehumidifier. The water collection container couples to the main body to receive water output by the dehumidifier device. The main body and the water collection container are configured so that the water collection container is disposed closer to a top of the dehumidifier than to a bottom of the dehumidifier. In preferred embodiments, the water collection container has a handle, and the handle is closer to the top of the dehumidifier than to the bottom of the dehumidifier. In specific embodiments, at least a portion of a bottom surface of the water collection container rests on at least a portion of a top surface of the main body. Preferably, at least a portion of the top surface of the water collection container is substantially flush with at least a portion of a top surface of the main body.

### BRIEF DESCRIPTION OF THE DRAWINGS

The various aspects and embodiments disclosed herein will be better understood when read in conjunction with the appended drawings, wherein like reference numerals refer to like components. For the purposes of illustrating aspects of the present application, there are shown in the drawings certain preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices. The drawings are not necessarily drawn to scale and are not in any way intended to limit the scope of this invention, but are merely presented to clarify illustrated embodiments of the invention. In these drawings:

FIG. 1 is a perspective view of an embodiment dehumidifier.

### DETAILED DESCRIPTION OF THE PREFERRED EMBODIMENTS

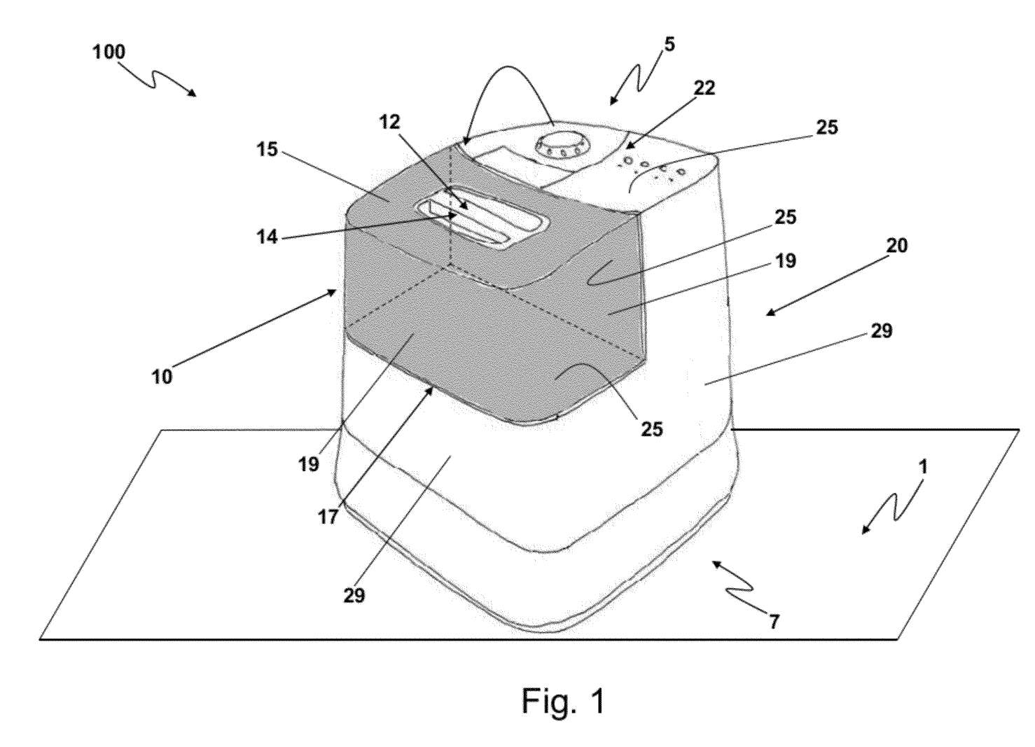

An embodiment of a top-emptying dehumidifier 100 is shown in FIG. 1. The top-emptying dehumidifier 100 generally includes the elements of a conventional dehumidifier, as are well-known to persons of ordinary skill in the art and as are exemplified by, inter alia, U.S. Pat. No. 5,611,209, the contents of which are incorporated herein by reference.

The top-emptying dehumidifier 100 includes a removable water collection container 10 and a main body 20. The main body 20 is defined by a housing that contains and supports the structural, mechanical and/or electrical components required to dehumidify air surrounding or fed into the dehumidifier 100, including controls 22 that enable a user to control operations of a dehumidifying device 101 within the housing of main body 20. The water collection container 10 is designed to structurally and fluidly mate with main body 20 in a removable manner so that the water collection container 10 can be periodically emptied of water that is collected by the dehumidifying equipment within main body 20 and deposited within the water collection container 10.

The water collection container 10 is located at or near the top 5 of the top-emptying dehumidifier 100. That is, in preferred embodiments, the water collection container 10 is located closer to the top 5 of the dehumidifier 100 than it is to the bottom 7 of the dehumidifier 100, in which, during normal operations, it is the bottom 7 of the dehumidifier 100 that rests upon a surface 1. In particularly preferred embodiments, a handle 12 of water collection container 10 is located closer to the top 5 of the dehumidifier 100 than it is to the bottom 7 of the dehumidifier 100. An exemplary embodiment of the removable water collection container 10 is depicted as the hatched portion of FIG. 1. In the embodiment dehumidifier 100, a bottom surface 17 of the water collection container 10 rests on an upper face 25 of the main body 20. Note that the upper face 25 of the main body 20 is stepped, forming a recess that accommodates the water collection container 10 in a manner that creates a continuous shape to the external surfaces of the dehumidifier 100 when assembled. Hence, a top surface 15 and side surfaces 19 of the water collection container 10 are dimensioned so as to be flush with a corresponding portion of the upper face 25 and side surfaces 29 of the main body 20.

As noted above, in some embodiments, including the embodiment that is depicted in FIG. 1, the removable water collection container 10 includes a handle 12 that may be grasped by a user. In some embodiments, the removable water collection container 10 and the handle 12 are positioned to permit the user to remove the water collection container 10 from the main body 20 of dehumidifier 100 by pulling upwards on the handle 12. In some embodiments, the removable water collection container 10 and the handle 12 are oriented such that, after removing the removable water collection container 10 from the main body 20, the user may carry the removable water collection container 10 by holding the handle 12. Hence, the handle 12 may define an opening 14 through which the user may pass the fingers of his or her hand so as to better grasp the handle 12.

In operation, the removable water collection container 10 stores water that is removed from the air by the main body 20. The water which is removed from the air may be introduced into the removable water collection container 10 by way of a pump or similar mechanism for moving water, as is well known in the art of water/air handling devices, such as dehumidifiers. The user may remove the removable water collection container 10 from the dehumidifier 100; for example, in order to empty the water collection container 10 after it has become full or substantially full with water. In the embodiments in which the removable water collection container 10 includes a handle 12, the user may remove the removable water collection container 10 from the main body 20 by pulling upwards on the handle 12. After removing the removable water collection container 10 from the main body 20, the user may empty it and then re-insert it into its position in the dehumidifier 100.

Because the removable water collection container 10, and in particular the handle 12, is located at or near the top 5 of the top-emptying dehumidifier 100, the user either need not bend down at all, or else need not bend down as far, to grasp the removable water collection container 10 as would be required if it were located at or near the bottom 7 of the dehumidifier 100. Accordingly, the top-emptying dehumidifier 100 of the present invention improves on the dehumidifiers of the prior art. Specifically, because the user either need not bend down at all, or else need not bend down very far, to grasp the removable water collection container, the user's comfort is increased, the likelihood of injury is decreased, and the likelihood of unintentionally spilling water is decreased.

In some embodiments, the top-emptying dehumidifier also includes a noise-reduction system. The noise-reduction system significantly reduces the noise that the top-emptying dehumidifier generates during operation, resulting in an improved user experience.

One having ordinary skill in the art will recognize that the various mechanisms described for the preferred embodiments of the dehumidifier may be adapted and interchanged between the preferred embodiments, without significantly impacting the structure and operation of the dehumidifier. Those skilled in the art will recognize that the present invention has many applications, may be implemented in many manners and, as such is not to be limited by the foregoing embodiments and examples. Any number of the features of the different embodiments described herein may be combined into one single embodiment, the locations of particular elements can be altered and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there had been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A dehumidifier comprising:
a main body comprising a dehumidifier device to dehumidify air surrounding or fed into the dehumidifier; and
a water collection container removably and fluidly coupled to the main body and configured to receive water output by the dehumidifier device;
wherein the main body and the water collection container are configured so that the water collection container couples to the main body at a location with respect to the main body such that the water collection container is closer to a top of the dehumidifier than to a bottom of the dehumidifier.

2. The dehumidifier of claim 1 wherein the water collection container comprises a handle and the handle is closer to the top of the dehumidifier than to the bottom of the dehumidifier.

3. The dehumidifier of claim 2 wherein the handle is disposed on the top of the water collection container.

4. The dehumidifier of claim 1 wherein the water collection container is disposed at the top of the dehumidifier.

4. The dehumidifier of claim 1 wherein at least a portion of a top surface of the water collection container is substantially flush with at least a portion of a top surface of the main body.

5. The dehumidifier of claim 1 wherein at least a portion of a bottom surface of the water collection container rests on an upper face of the main body.

6. A dehumidifier comprising:
a main body comprising:
a housing having a top surface and a bottom surface, the top surface being shaped so as to define a recess in an upper portion of the housing; and
a dehumidifier device disposed within the housing, the dehumidifier device dehumidifying air surrounding or fed into the dehumidifier; and
a water collection container removably disposed in and fluidly coupled to the recess of the main body, the water collection container configured to receive water output by the dehumidifier device.

7. The dehumidifier of claim 6 wherein the water collection container comprises a handle and the handle is disposed closer to the top surface of the main body than to the bottom surface of the main body.

8. The dehumidifier of claim 7 wherein the handle is disposed on a top surface of the water collection container.

9. The dehumidifier of claim 6 wherein at least a portion of a top surface of the water collection container is substantially flush with at least a portion of the top surface of the main body.

10. The dehumidifier of claim 6 wherein an upper face of the housing is stepped to define the recess, and at least a portion of a bottom surface of the water collection container rests on at least a portion of the upper face.
